(19) United States
(12) Patent Application Publication
(10) Pub. No.: US 2004/0133507 A1
(43) Pub. Date: Jul. 8, 2004

(54) Method and system for conducting financial transactions using single use credit card numbers

(76) Inventor: Paul Barbour, Baldwinsville, NY (US)

Correspondence Address: BAKER & BOTTS, 30 ROCKEFELLER PLAZA, NEW YORK, NY, 10112

(21) Appl. No.: 10/336,417

(22) Filed: Jan. 2, 2003

(51) Int. Cl. G06F 17/60

(52) U.S. Cl. 705/38

(57) ABSTRACT

The present invention is directed to a method for executing one or more financial transactions over a communication path for an account holder having an account associated with a permanent account number, where the permanent account number is deactivated for financial transactions over a communication path. A single use number associated with the permanent account number is issued, where funds authorized for transfer using the single use number are drawn from the account of the account holder. The single use number is inactive prior to the account holder requesting activation of the single use number. The single use number is then activated in response to a request for activation made by the account holder to activate the single use number. Funds are then transferred from the account in response to the account holder authorizing the transfer of funds using the single use number, where the transfer of funds using the single use account number occurs within a predetermined period of time following the activation of the single use number. The single use number is then deactivated after completion of the transfer of funds.

### FIELD OF THE INVENTION

The present invention relates generally to a method and system for conducting financial transactions using a credit card. In particular, the present invention relates to a method and system for conducting financial transactions using credit card numbers which are deactivated after use.

### BACKGROUND OF THE INVENTION

Studies show that many consumers who make use of the World Wide Web are reluctant to conduct financial transactions on the Web. This reluctance is primarily due to the need to conduct such transactions using credit cards, and to the accompanying concern that the credit-card numbers might be stolen by on-line hackers. Accordingly, consumers are worried that their credit-card numbers will be used by unauthorized persons. They are also concerned about the fact that a thief may use a consumer's name, credit-card number, and other identifiers to create a new identity associated with the consumer. Thieves may use this new identity to open accounts in the consumer's name, charging the stolen credit card and leaving the consumer to pay the bills. The Web is a particularly attractive source of credit card numbers for hackers. Since thousands of credit card numbers are typically stored in a merchant's database, breaking into the database gives a hacker the opportunity for credit-card and identity theft on a large scale.

Therefore, the volume of business on the Web is estimated to be only a fraction of its potential. While consumers readily obtain information related to product availability and prices from the Web, they often purchase the items of interest by visiting a store rather than shopping on-line.

Credit-card issuers have been investigating new technologies to address these concerns. Among the most promising developments in this regard are systems for creating “disposable” or “single use” credit-card numbers. As used herein and in the credit card industry, a “disposable” or “single use” credit-card number is a number which is used once for a financial transaction, and rendered invalid thereafter.

In the systems described at http://www.ecommercetimes.com/perl/story/4230.html; http://news.com.com/2100-1017-245428.html?legacy=cnet; http://www.bankrate.com/brm/news/cc/20021001a.asp; http://www.bankrate.com/brm/news/cc/20021001b.asp; http://www.washingtonpost.com/ac2/wp-dyn/A36252-2000Oct18; http ://www.orbiscom.com/press/industry/060301.html; and http://techupdate.zdnet.com/techupdate/stories/main/0,14179,2625758,00.html, a user logs on to a credit card issuer's web site and selects the credit card that the user wishes to use for an online purchase. A single use virtual card number, associated with a credit card account is then generated and used by the consumer for the purchase. The item purchased is charged to the credit card and appears on the monthly billing statement. The lifespan of the single use virtual card number may be limited to a few days. Alternatively, the single use virtual card number may expire when the credit card number expires. Once used, the single use virtual card number is invalid and is therefore of no use to a potential hacker who might steal the virtual card number.

U.S. Pat. No. 6,339,766 and U.S. patent application Publication No. U.S. 2001/0047330 describe a system in which a limited-use account is established together with the credit card account. The limited-use account number may be used either for a specified period of time or for a specified number of transactions, after which the limited-use account number is deactivated until the credit card account owner requests activation of the limited-use account number.

U.S. patent application Publication No. U.S. 2002/0032649 describes an electronic currency ID associated with a credit car account. The system may be used to conduct on-line purchases and may also be used to make recurring payments using the electronic currency.

U.S. Pat. No. 5,259,649 describes a credit card which bears, in addition to the correct identification number, a number of further digits or letters, so that a person obtaining the card in an unauthorized manner cannot identify the correct number.

None of the foregoing systems, however, provide for deactivation of the permanent credit card number for on-line or telephone purchases. Furthermore, only one single use number is issued at any one time in the foregoing systems, so that if the consumer requires a new single use number, the consumer has to access the Web once again to obtain the new single use number, which results in inconvenience. Thus, there is a need in the art for a system that solves these concerns. The present invention satisfies this requirement.

### SUMMARY OF THE INVENTION

The present invention in one embodiment is directed to a method for executing a financial transaction over a communication path for an account holder having an account associated with a permanent account number, where the permanent account number is deactivated for financial transactions over the communication path. A single use number associated with the permanent account number is issued, where funds authorized for transfer using the single use number are drawn from the account of the account holder. The single use number is inactive prior to the account holder requesting activation of the single use number. The single use number is then activated in response to a request for activation made by the account holder to activate the single use number. Funds are then transferred from the account in response to the account holder authorizing the transfer of funds using the single use number, where the transfer of funds using the single use account number occurs within a predetermined period of time following the activation of the single use number. The single use number is then deactivated after completion of the transfer of funds.

The present invention in another embodiment is directed to a method for executing one or more financial transactions over a communication path for an account holder having an account associated with a permanent account number, where the permanent account number is deactivated for financial transactions over the communication path. A plurality of single use numbers associated with the permanent account number is issued, where funds authorized for transfer using any one of the plurality of the single use numbers are drawn from the account of the account holder. The plurality of the single use numbers is inactive prior to the account holder requesting activation of a first single use number. The first single use number is then activated in response to a request for activation made by the account holder to activate the first single use number. The remaining single use numbers remain inactive. Funds are then transferred from the account in response to the account holder authorizing the transfer of funds using the first single use number. The transfer of funds using the first single use number occurs within a predetermined period of time following the activation of the first single use number. The first single use number is then deactivated after completion of the transfer of funds.

The present invention in another embodiment is directed to a method for executing one or more financial transactions over a communication path for an account holder having an account associated with a permanent account number, wherein the permanent account number is deactivated for financial transactions over the communication path. The method includes providing a data storage device. A data set is stored in the data storage device. The data set includes (i) an account associated with an account holder, (ii) a permanent account number associated with the account, (iii) a plurality of single use numbers associated with the permanent account number, where funds authorized for transfer using any one of the plurality of the single use numbers are drawn from the account, and (iv) a plurality of identifiers, where each one of the plurality of identifiers corresponds to a single use number out of the plurality of the single use numbers. Each one of the plurality of identifiers has a value indicating whether the corresponding single use number is activated or inactive. The plurality of the single use numbers is inactive prior to the account holder requesting activation of a first single use number. The data set is then modified in response to a request for activation made by the account holder to activate the first single use number. The modification to the data set includes modifying the value of the identifier corresponding to the activated first single use number to indicate that the first single use number has been activated. The value of the remaining identifiers corresponding to the remaining single use numbers is not modified. A transfer of funds is then initiated from the account in response to the account holder making an authorization using the activated first single use number. The data set is then modified after initiating the transfer of funds. The modification includes modifying the value of the identifier corresponding to the first single use number to indicate that the first single use number has been deactivated.

The present invention in another embodiment is directed to a system for executing one or more financial transactions over a communication path for an account holder having an account associated with a permanent account number, wherein the permanent account number is deactivated for financial transactions over the communication path. The system includes a data storage device. A data set is stored in the data storage device. The data set includes (i) an account associated with an account holder, (ii) a permanent account number associated with the account, (iii) a plurality of single use numbers associated with the permanent account number, where funds authorized for transfer using any one of the plurality of the single use numbers are drawn from the account, and (iv) a plurality of identifiers, where each one of the plurality of identifiers corresponds to a single use number out of the plurality of the single use numbers. The system also includes means to initiate the transfer of funds from the account. Each one of the plurality of identifiers is associated with a value indicating whether the corresponding single use number is activated or inactive. The value of each one of the plurality of identifiers is capable of being modified in response to a request for activation of the corresponding single use number to indicate activation of the corresponding single use number and the value of each one of the plurality of identifiers is capable of being further modified to indicate deactivation of the corresponding single use number following the initiation of a transfer of funds.

The present invention in another embodiment is directed to a method for authorizing one or more financial transactions over a communication path by an account holder having an account associated with a permanent account number, where the permanent account number is deactivated for financial transactions over the communication path. The account holder receives a plurality of single use account numbers associated with the permanent account number, where funds authorized for transfer using any one of the plurality of the single use numbers are drawn from the account. The plurality of the single use numbers is inactive prior to the account holder requesting activation of a first single use number. The account holder then requests activation of the first single use number without requesting activation of the remaining single use numbers. The remaining single use numbers remain inactive. The account holder authorizes transferring of funds from the account using the first single use number. The transfer of funds using the first single use number occurs within a predetermined period of time following the activation of the first single use number.

The present invention provides for deactivation of the permanent account number, such as a credit card number, for financial transactions over a communication path. Accordingly, it is not possible for a thief who obtains possession of the consumer's credit card bill to use the permanent credit card number for financial transactions over the communication path. Furthermore, more than one single use number may be issued at any one time, so that the consumer is not required to access the Web every time the consumer needs to authorize a financial transaction. Accordingly, the present invention is advantageous in terms of both protection from thieves or hackers and consumer convenience.

### BRIEF DESCRIPTION OF THE DRAWINGS

Exemplary embodiments of the present invention will now be described in detail with reference to the accompanying drawings in which:

FIGS. 1a and 1b are schematic diagrams illustrating the system of the invention; and

FIG. 2 is a flowchart illustrating the method of the invention.

### DETAILED DESCRIPTION OF THE INVENTION

The permanent account number of the account holder is deactivated for financial transactions over a communication path. The account may be, for example, a credit card account or a deposit account to which the account holder deposits funds. The account of the account holder is issued by an account issuer, which is typically a credit card issuer. The issuer also typically maintains a computer system for executing the method of the invention. Both the holder of the account and the merchant are protected from fraud by the method of the invention, since a stolen credit card number is of no use to a hacker or thief for the purposes of financial transactions over a communication path. In one embodiment of the invention, the permanent account number of the account holder is deactivated at a request by the account holder. The permanent account number may be subsequently reactivated at a later request by the account holder.

As used herein, the phrase “financial transaction over a communication path” is intended to refer to an on-line financial transaction or a telephonic financial transaction.

Individual single use numbers or a plurality of single use numbers may be generated as random numbers by a computer program or may be generated by the issuer of the account, which is typically a credit card issuer. A plurality of single use numbers may be pre-generated prior to the use of any one of the plurality of single use numbers. Each single use number is associated with the account holder's permanent account number. To conduct financial transactions over a communication path, the account holder contacts the credit card issuer by telephone or computer and activates a single use number. A separate password may also be associated with each single use number or with a plurality of single use numbers. Knowledge of the single use numbers does not provide access to the permanent account number associated with the account of the account holder.

More than one single use number out of the plurality of single use numbers may be used at substantially the same time. One or more financial transactions may be executed following authorization by the consumer for each single use number. In one embodiment of the invention, only one financial transaction is executed for each single use number. Once used, a single use number is deactivated and may not be used again. Once the account holder has used a certain number of the single use numbers, the credit card issuer may automatically generate more single use numbers and make them available to the account holder.

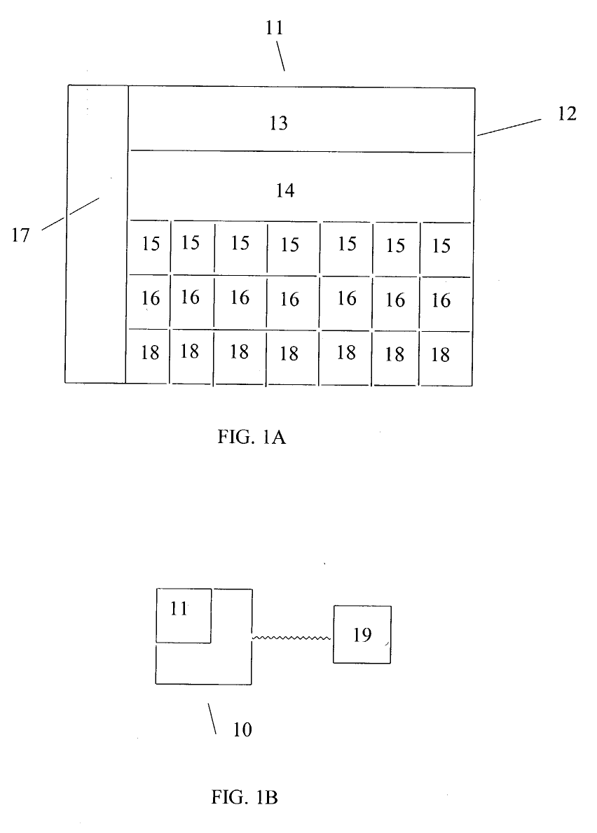

Reference is now made to FIG. 1a, which shows schematically the system of the present invention. The system includes a data storage device 11. A data set 12 is stored in the data storage device. The data set includes (i) an account 13 associated with an account holder, (ii) a permanent account number 14 associated with the account, (iii) a plurality of single use numbers 15 associated with the permanent account number, and (iv) a plurality of identifiers 16. Each identifier 16 corresponds to a single use number 15. Funds authorized for transfer using any one of the single use numbers 15 are drawn from the account 13. The system also includes means 17 to initiate the transfer of funds from the account. Each identifier 16 is associated with a value 18 indicating whether the corresponding single use number is activated or inactive. The value 18 is capable of being modified in response to a request for activation of the corresponding single use number 15 to indicate activation of the corresponding single use number 15. The value 18 is also capable of being modified to indicate deactivation of the corresponding single use number 15 following the initiation of a transfer of funds. As is further shown in the embodiment of FIG. 1b, the data storage device 11 may be part of a computer system 10 connected to the Web 19.

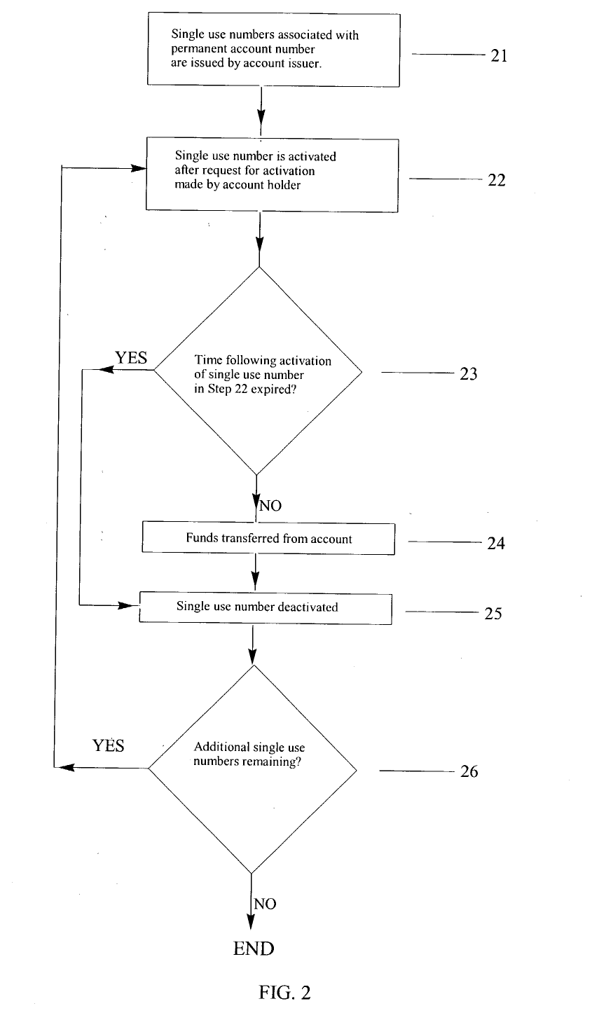

Reference is now made to FIG. 2, which is a flowchart illustrating the method of the present invention. In step 21, a plurality of single use numbers is associated with a permanent account number issued by an account issuer. The single use numbers are also issued by the account issuer. Funds authorized for transfer using any one of the single use numbers are drawn from the account of the account holder. The single use numbers are inactive prior to the account holder requesting activation of a first single use number. A single use number is then activated in step 22 in response to a request for activation made by the account holder to activate the single use number. The remaining single use numbers remain inactive. The transfer of funds using the single use number activated in step 22 must occur within a predetermined period of time following the activation of the single use number. Decision block 23 determines whether to authorize transfer of the funds in response to the account holder authorizing the transfer of funds using the single use number activated in step 22. If the predetermined period of time has not expired, transfer of the funds from the account is authorized in step 24 and the single use number activated in step 22 is deactivated in step 25 after completion of the transfer of funds. If the predetermined period of time has expired, transfer of the funds is not authorized and the single use number is deactivated in step 25. A second decision block 26 determines whether there are additional single use numbers which can be used. If there are additional single use numbers remaining, steps 22 to 25 can be repeated for each remaining single use number available to the account holder.

After the first single use number out of a plurality of single use numbers is deactivated, one or more of the remaining single use numbers may be activated. In one embodiment of the invention, only one of the remaining single use numbers is activated. Funds are then transferred from the account holder's account in response to the account holder authorizing the transfer of funds using the single use number which has been activated. Authorizing the transferring of funds may include transmitting a message to the account issuer. The transfer of funds occurs within a predetermined period of time following the activation of the single use number. The predetermined period of time may be selected by the account holder or by the credit card issuer. After the transfer of funds is completed, the single use number may be deactivated. Alternatively, if funds are transferred to a specific merchant account, the single use number may remain active to allow additional transfers of funds to the same specific merchant account, and is then deactivated after the additional transfers of funds have been completed. The sequence which includes activation of one of the remaining single use numbers, transfer of funds in response to the account holder's authorization, and deactivation of the single use number after the transfer of funds is completed, may be iteratively repeated provided that the single use number activated in each iteration is different from any single use number deactivated in any previous iteration. The iterations may continue until all the single use numbers are deactivated.

Since a plurality of single use numbers may be issued to the account holder, the account holder may authorize telephonically the activation of any one of the single use numbers. The single use number or numbers may be provided to the account holder in a variety of ways. For example, the single use number or numbers may be printed on the account holder's credit card, printed on a separate card, listed online on a Web page which the account holder may access by providing a password, or listed separately in a list which may be provided to the account holder in person, by mail, or other non-electronic means. The account holder may receive the plurality of single use numbers at the same time or substantially the same time as he or she receives the permanent account number. For example, the account holder may receive a card having encoded thereon the permanent account number and the plurality of single use numbers. The plurality of single use numbers may be encoded on the card and concealed by a removable cover. The removable cover may be removed by scratching the cover to reveal the single use numbers concealed thereunder.

After the value of the identifier in the data set is modified to indicate that the first single use number has been deactivated, the data set may be modified in response to a request for activation made by the account holder to activate one or more of the remaining single use numbers. For example, if the account holder requests to activate one of the remaining single use numbers, the value of the identifier corresponding to the activated single use number is modified to indicate that the single use number has been activated. A transfer of funds is then initiated from the account in response to the account holder making an authorization using the single use number. The transfer of funds using the single use number occurs within a predetermined period of time following the activation of the single use number. After the transfer of funds has been initiated, the value of the identifier corresponding to the single use number is again modified to indicate that the single use number has been deactivated. Alternatively, if funds are transferred to a specific merchant account, the single use number may remain active to allow additional transfers of funds to the same specific merchant account. The value of the identifier corresponding to the single use number is then modified after the additional transfers of funds have been completed to indicate that the single use number has been deactivated. The sequence which includes modification of the identifier to indicate that the single use number has been activated, initiation of the transfer of funds, and modification of the identifier to indicate that the single use number has been activated, may be iteratively repeated provided that the single use number activated in each iteration is different from any single use number deactivated in any previous iteration. The iterations may continue until all the single use numbers are deactivated.

In addition to providing convenience and protection to the consumer, the present invention in one embodiment allows for the authorization and execution of more than one financial transaction, including recurring payments such as bills for phone service through an Internet service provider, for each single use number. The account holder may allocate a single use number for this use to a specific merchant, such as a telephone company. This single use number is not eligible for purchases with any other merchant, and can be cancelled by the account holder at any time. Similarly, the financial transactions may also include reserving a variety of items such as rental cars, airline flights, hotels, and theatre tickets, and pre-ordering of unreleased books, CDs, videos or DVDs. A single use number authorized by the account holder is usable for a predetermined period of time which is authorized by a merchant. The predetermined period of time is sufficient for the purpose of reserving or pre-ordering the items or articles above. Funds are set aside from the account controlled by the permanent account number. As in other embodiments of the invention, knowledge of the single use numbers does not provide access to the permanent account number associated with the account of the account holder.

It should be understood that various changes and modifications to the preferred embodiments described herein will be apparent to those skilled in the art. Such changes and modifications can be made without departing from the spirit and scope of this invention and without diminishing its attendant advantages. It is therefore intended that such changes and modifications be covered by the appended claims.

I claim:

1. A method for executing a financial transaction over a communication path for an account holder having an account associated with a permanent account number, wherein the permanent account number is deactivated for financial transactions over a communication path, the method comprising:
a) issuing a single use number associated with the permanent account number, wherein funds authorized for transfer using the single use number are drawn from the account and the single use number is inactive prior to the account holder requesting activation of the single use number;
b) activating the single use number in response to a request for activation made by the account holder to activate the single use number;
c) transferring funds from the account in response to the account holder authorizing the transfer of funds using the single use number, wherein the transfer of funds using the single use account number occurs within a predetermined period of time following the activation of the single use number; and
d) deactivating the single use number after completion of the transfer of funds in step (c).

2. A method for executing one or more financial transactions over a communication path for an account holder having an account associated with a permanent account number, wherein the permanent account number is deactivated for financial transactions over a communication path, the method comprising:
a) issuing a plurality of single use numbers associated with the permanent account number, wherein funds authorized for transfer using any one of the plurality of the single use numbers are drawn from the account and the plurality of the single use numbers is inactive prior to the account holder requesting activation of a first single use number;
b) activating the first single use number in response to a request for activation made by the account holder to activate the first single use number, wherein the remaining single use numbers remain inactive;
c) transferring funds from the account in response to the account holder authorizing the transfer of funds using the first single use number, wherein the transfer of funds using the first single use number occurs within a predetermined period of time following the activation of the first single use number; and
d) deactivating the first single use number after completion of the transfer of funds in step (c).

3. The method of claim 2, further comprising:
e) activating only one of the remaining single use numbers;
f) transferring funds from the account in response to the account holder authorizing the transfer of funds using the single use number activated in step (e), wherein the transfer of funds using the single use number activated in step (e) occurs within a predetermined period of time following the activation of the single use number activated in step (e); and
g) deactivating the single use number activated in step (e) after completion of the transfer of funds in step (f).

4. The method of claim 3, further comprising:
h) iteratively repeating steps e) to g), with the proviso that the single use number activated in step (e) in each iteration is different from any single use number deactivated in step (g) in any previous iteration, until all the single use numbers are deactivated.

5. The method of claim 2, wherein the one or more financial transactions are telephonic financial transactions.

6. The method of claim 2, wherein the predetermined period of time is selected by the account holder.

7. A method for executing one or more financial transactions over a communication path for an account holder having an account associated with a permanent account number, wherein the permanent account number is deactivated for financial transactions over a communication path, the method comprising:
a) providing a data storage device;
b) storing in the data storage device a data set comprising (i) an account associated with an account holder, (ii) a permanent account number associated with the account, (iii) a plurality of single use numbers associated with the permanent account number, wherein funds authorized for transfer using any one of the plurality of the single use numbers are drawn from the account, and (iv) a plurality of identifiers, wherein each one of the plurality of identifiers corresponds to a single use number out of the plurality of the single use numbers and has a value indicating whether the corresponding single use number is activated or inactive, wherein the plurality of the single use numbers is inactive prior to the account holder requesting activation of a first single use number;
c) modifying the data set in response to a request for activation made by the account holder to activate the first single use number, wherein the modification comprises modifying the value of only the identifier corresponding to the activated first single use number to indicate that the first single use number has been activated;
d) initiating a transfer of funds from the account in response to the account holder making an authorization using the activated first single use number; and
e) modifying the data set after initiating the transfer of funds in step (d), wherein the modification comprises modifying the value of the identifier corresponding to the first single use number to indicate that the first single use number has been deactivated.

8. The method of claim 7, further comprising:
f) modifying the data set in response to a request for activation made by the account holder to activate only one of the remaining single use numbers, wherein the modification comprises modifying the value of the identifier corresponding to the activated single use number to indicate that the single use number has been activated;
g) initiating a transfer of funds from the account in response to the account holder making an authorization using the single use number activated in step (f), wherein the transfer of funds using the single use number activated in step (f) occurs within a predetermined period of time following the activation of the single use number activated in step (f); and
h) modifying the data set after initiating the transfer of funds in step (g), wherein the modification comprises modifying the value of the identifier corresponding to the single use number activated in step (e) to indicate that the single use number activated in step (e) has been deactivated.

9. The method of claim 8, further comprising:
i) iteratively repeating steps f) to h), with the proviso that the single use number activated in step (f) in each iteration is different from any single use number deactivated in step (h) in any previous iteration, until all the single use numbers are deactivated.

10. The method of claim 7, wherein the financial transaction is a telephonic financial transaction.

11. The method of claim 7, wherein the predetermined period of time is selected by the account holder.

12. A method for authorizing one or more financial transactions over a communication path by an account holder having an account associated with a permanent account number, wherein the permanent account number is deactivated for financial transactions over a communication path, the method comprising:
a) the account holder receiving a plurality of single use account numbers associated with the permanent account number, wherein funds authorized for transfer using any one of the plurality of single use numbers are drawn from the account and the plurality of the single use numbers is inactive prior to the account holder requesting activation of a first single use number;
b) the account holder requesting activation of only the first single use number, wherein the remaining single use numbers remain inactive; and
c) the account holder authorizing transferring of funds from the account using the first single use number, wherein the transfer of funds using the first single use number occurs within a predetermined period of time following the activation of the first single use number.

13. The method of claim 12, wherein the first single use number is deactivated after completion of the transfer of funds.

14. The method of claim 12, further comprising:
d) the account holder requesting activation of only one of the remaining single use numbers; and
e) the account holder authorizing transferring of funds from the account using the single use number activated following the request in step (d), wherein the transfer of funds using the single use number activated in step (d) occurs within a predetermined period of time following the activation of the single use number activated following the request in step (d).

15. The method of claim 14, wherein the single use number activated following the request in step (d) is deactivated after completion of the transfer of funds.

16. The method of claim 15, further comprising:
f) the account holder iteratively repeating steps d) to e), with the proviso that the single use number activated following the request in step (d) in each iteration is different from any single use number deactivated after completion of the transfer of funds in any previous iteration, until all the single use numbers are deactivated.

17. The method of claim 12, wherein the account is issued by an account issuer and authorizing transferring of funds comprises transmitting a message to the account issuer.

18. The method of claim 12, wherein the financial transaction is a telephonic financial transaction.

19. The method of claim 12, wherein the predetermined period of time is selected by the account holder.

20. The method of claim 12, wherein the account holder receives the permanent account number and the plurality of single use numbers at the same time or substantially the same time.

21. The method of claim 12, wherein receiving the plurality of single use numbers associated with the permanent account number comprises receiving a card having encoded thereon the permanent account number and the plurality of single use numbers.

22. The method of claim 21, wherein each of the plurality of single use numbers encoded on the card is concealed by a removable cover.

23. The method of claim 22, wherein the removable cover may be removed by scratching the cover off the single use numbers concealed thereunder.

24. A system for executing one or more financial transactions over a communication path for an account holder having an account associated with a permanent account number, wherein the permanent account number is deactivated for financial transactions over a communication path, the system comprising:
(a) a data storage device;
(b) a data set stored in the data storage device, wherein the data set comprises
(i) an account associated with an account holder,
(ii) a permanent account number associated with the account,
(iii) a plurality of single use numbers associated with the permanent account number, where funds authorized for transfer using any one of the plurality of the single use numbers are drawn from the account, and
(iv) a plurality of identifiers, wherein each one of the plurality of identifiers corresponds to a single use number out of the plurality of the single use numbers, wherein each one of the plurality of identifiers is associated with a value indicating whether the corresponding single use number is activated or inactive, and the value of each one of the plurality of identifiers is capable of being modified in response to a request for activation of the corresponding single use number to indicate activation of the corresponding single use number, and the value of each one of the plurality of identifiers is capable of being further modified to indicate deactivation of the corresponding single use number following the initiation of a transfer of funds; and
(c) means to initiate the transfer of funds from the account.
